(19) United States
(12) Patent Application Publication
(10) Pub. No.: US 2015/0169815 A1
(43) Pub. Date: Jun. 18, 2015

(54) HARMONIC DISTORTION VS. OUTPUT LOADING MACRO-MODELING

(71) Applicant: Texas Instruments Incorporated, Dallas, TX (US)

(72) Inventors: HERMAN THEODORUS, DALLAS, TX (US); MARCOS L. LOPEZ, ADDISON, TX (US); JOHN E. MILLER, PLANO, TX (US); ARASH LOLOEE, ALLEN, TX (US)

(21) Appl. No.: 14/574,616

(22) Filed: Dec. 18, 2014

Related U.S. Application Data
(60) Provisional application No. 61/917,585, filed on Dec. 18, 2013.

(51) Int. Cl. G06F 17/50

(52) U.S. Cl. CPC G06F 17/5036

(57) ABSTRACT

A method of harmonic distortion (HD) versus load modeling. A macro-model circuit is provided including a sub-circuit block(s) modeling an electronic device and an HD generation block in a signal path of the macro-model circuit that includes an HD equation relating a load current parameter responsive to an input voltage (Vin(t)). Responsive to receiving Vin(t) at an input of the macro-model circuit under a set of operating conditions including the output of the macro-model circuit loaded with an output impedance (Z), a simulated load current (iL) is generated. iL or another load current from iL (iL′) is fed back to the HD generation block to provide its load current parameter. The load current parameter is inputted into the HD equation for the HD equation to become a substituted equation. At least one simulated HD value under loading by Z for the electronic device is generated from the substituted equation.

### CROSS REFERENCE TO RELATED APPLICATIONS

This application claims the benefit of Provisional Application Ser. No. 61/917,585 entitled “Harmonic Distortion vs. Loading macro modeling” filed on Dec. 18, 2013, which is herein incorporated by reference in its entirety.

### FIELD

Disclosed embodiments relate to harmonic distortion macro-models for simulating Harmonic Distortion vs. output load for electronic circuits.

### BACKGROUND

Circuit designers need macro-models that can precisely and accurately predict the behavior of an actual electronic device in their particular application to avoid the need to build breadboards for actual testing. Circuit simulation programs, of which Simulation Program with Integrated Circuit Emphasis (SPICE) and its derivatives are the most often used, take a text netlist describing the circuit elements (transistors, resistors, capacitors, etc.) and their connections, and translate this description into equations to be solved. The general equations produced are nonlinear differential algebraic equations which are solved using implicit integration methods, Newton's method and sparse matrix techniques.

SPICE macro-models have evolved over the past decade, and new models allow users to duplicate characterization data on their computers. Unfortunately, most electronic circuit simulation models that claim to provide circuit designers with accurate simulation data actually do not duplicate the actual behavior of the device, at least for certain parameters, and some available SPICE models also still lack certain parameters. For example, most available simulation models do not adequately simulate noise or distortion, generally providing erroneous and misleading readings even for relatively simple circuits such as low-noise precision operational amplifiers. As known in the art, “noise” describes the random electrical signals produced by the device, while “distortion” refers to unwanted harmonics introduced by the device.

### SUMMARY

This Summary briefly indicates the nature and substance of this Disclosure. It is submitted with the understanding that it will not be used to interpret or limit the scope or meaning of the claims.

Disclosed embodiments recognize there are no known macro-modeling solutions for modeling harmonic distortion (HD) vs. output loading at the macro-modeling level that can provide universality and ease-of-use. Universality refers to the disclosed solution being able to (i) be applied across the boundary of different circuit architectures/circuit categories with only the need to insert the disclosed solution in between existing sub-circuit blocks of a macro-model or otherwise in the signal path of the sub-circuit blocks, and (ii) with no needed changes to the sub-circuit blocks for converting an existing non-HD macro model into a macro-model that describes the HD behavior of the electronic device.

Ease-of-use refers to the solution being capable of use by a macro-model engineer having ordinary skill in the art without requiring the macro-model engineer to possess a thorough understanding of the circuit architecture (or years of experience), significant time (e.g., several weeks) to do trial and error work, and the ability to obtain access to a circuit database or circuit design database. HD values as a function of an equivalent output impedance (Z) generated by disclosed methods can be expressed as a particular harmonic of a fundamental frequency such as the first harmonic (HD1) or second harmonic (HD2), or as a total harmonic distortion (THD) which is a common measurement for the level of HD present in certain devices.

Disclosed embodiments include methods of HD versus load modeling for electronic circuits. A macro-model circuit is provided including sub-circuit block(s) modeling an electronic device and an HD generation block in a signal path of the macro-model circuit that includes an HD equation relating a load current parameter responsive to an a time-varying input voltage (Vin(t)). The sub-circuit block(s) used for modeling the electronic device can be known sub-circuit block(s).

Responsive to receiving Vin(t) at an input of the macro-model circuit under a set of operating conditions including the output of the macro-model circuit loaded with an output impedance (Z), a simulated load current (iL) is generated. iL or another load current derived from iL (iL′) is fed back to the HD generation block to provide its load current parameter. The load current parameter is inputted into the HD equation for the HD equation to become a substituted equation. At least one simulated HD value under loading by Z for the electronic device is generated from the substituted equation.

### BRIEF DESCRIPTION OF THE DRAWINGS

Reference will now be made to the accompanying drawings, which are not necessarily drawn to scale, wherein:

FIG. 1 is a flow chart that shows steps in an example method of HD versus load modeling for electronic devices, according to an example embodiment.

FIG. 2A is a block diagram of an example macro-model circuit comprising a first sub-circuit block and a second sub-circuit block where the HD generation block is positioned after the second sub-circuit block, shown having iL or iL′ fed back to the HD generator block, according to an example embodiment.

FIG. 2B is a block diagram of an example macro-model circuit comprising a first sub-circuit block and a second sub-circuit block, where the HD generation block is positioned between the first sub-circuit block and the second sub-circuit block, shown having iL or iL′ fed back to the HD generator block, according to an example embodiment.

FIG. 3A shows a plot of HD vs. RL for a known behavioral macro-model that has no RL dependency in the HD equation and a plot of HD vs. RL for a disclosed method using a behavioral macro-model that has an RL dependency.

FIG. 3B shows a plot of HD vs. RFB for a known behavioral macro-model that has no RFB dependency in the HD equation and a plot of HD vs. RFB for a disclosed method using a behavioral macro-model that has an RFB dependency.

FIG. 4 shows a macro-model circuit portion that together with a mathematical manipulation described below is used to generate HD2 and HD3 as a function of a load impedance for an electronic device.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

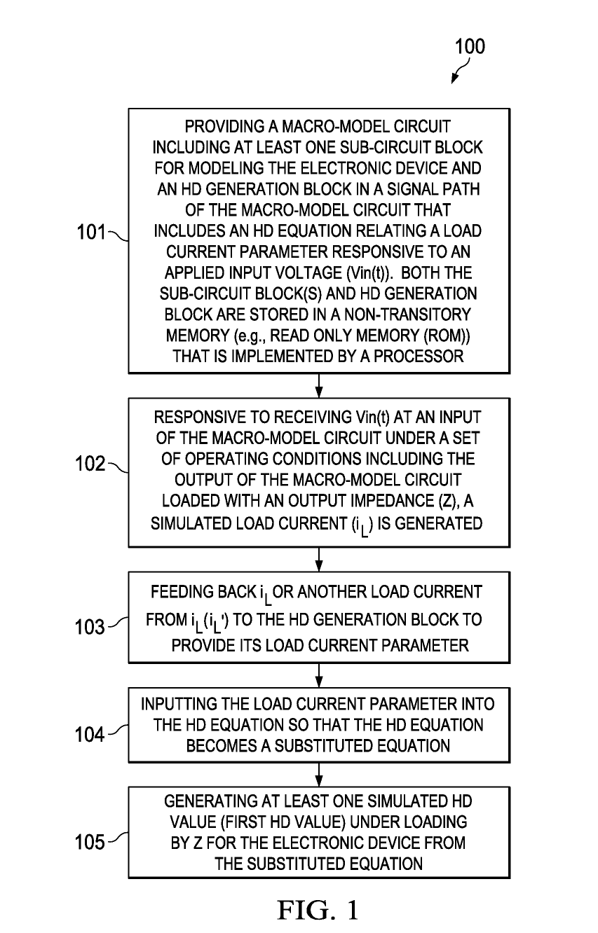

FIG. 1 is a flow chart that shows steps in an example method 100 of HD versus load modeling for electronic devices, according to an example embodiment. The electronic device can comprise a variety of integrate circuit (IC) types, such as an amplifier or a buffer, or another electronic circuit type that can have a macro-model for the circuit generated which can generally be any electronic circuit. Step 101 comprises providing a macro-model circuit including at least one sub-circuit block for modeling the electronic device and an HD generation block in a signal path of the macro-model circuit that includes an HD equation relating a load current parameter responsive to an applied time-varying input voltage (Vin(t)). Both the sub-circuit block(s) and HD generation block are stored in a non-transitory memory (e.g., read only memory (ROM)) that is implemented by a processor.

In step 102, responsive to receiving Vin(t) at an input of the macro-model circuit under a set of operating conditions (e.g., conventional conditions such as power supply levels), Vin(t) defining the frequency and amplitude, temperature, etc. including the output node of the macro-model circuit loaded with an output impedance (Z), a simulated load current (iL) is generated. Step 103 comprising feeding back iL or another load current derived from iL (iL′) to the HD generation block to provide its load current parameter. Step 104 comprises inputting the load current parameter into the HD equation so that the HD equation becomes a substituted equation. Step 105 comprises generating at least one simulated HD value (first HD value) under loading by Z for the electronic device from the substituted equation.

The HD equation can be in the form comprising a1*Vin+a2*iL*²+a3*iL*³, where a1, a2 and a3 are each constants, and iL* comprises iL or iL′. Vin(t) can be a sinusoidal signal or any signal having frequency component(s)) providing a fundamental frequency, and the generating (step 105) can comprise using a half-angle formula to generate the first HD value at two times the fundamental frequency (2nd HD) (See Examples section below), and/or the generating step can comprise using a triple-angle formula to generate the first HD value at three times the fundamental frequency (3rd HD) (See Examples section below). Half-angle formulas are shown below:

sin² θ=[1−cos(2θ)]/2

cos² θ=[1+cos(2θ)]/2

tan² θ=[1−cos(2θ)]/2 divided by [1+cos(2θ)]/2

An example triple-angle formulas is shown below:

cos 3θ=4 cos³ θ−3 cos θ

The method can further comprise repeating the method after changing Z to a different Z (Z′), including responsive to receiving Vin(t) at the input of the macro-model circuit under a set of operating conditions including the output of the macro-model circuit being loaded with Z′. A simulated load current (second iL) is then generated, the second iL or another load current measure derived from the second iL (second iL′) fed back to the HD generation block to provide a second load current parameter for the HD generation block, and the second load current parameter is then input into the HD equation so that the HD equation becomes a substituted equation. A least one different simulated HD value (a second HD value) under loading by Z′ for the electronic device is then generated from the substituted equation.

The method can comprise generating a plot of HD versus output load using at least the first HD value and its associated Z, and the second HD value with its associated Z′. As used herein, the first and second HD value can be for any HD parameter (e.g., HD2, HD3, HD4, etc.), where the different impedance conditions (Z, Z′) produce different first and second HD values. The method can be implemented using a circuit netlist for the electronic device. In this embodiment, the macro-model circuit can be implemented using a circuit schematic editor or by a user directly typing to the circuit netlist. Disclosed macro-models can be made available on the Internet for world-wide customer downloads.

In one embodiment the sub-circuit block for modeling an electronic device comprises a first sub-circuit block and a second sub-circuit block. In this embodiment the HD generation block can be positioned before the first sub-circuit block, between the first sub-circuit block and the second sub-circuit block, or after the second sub-circuit block.

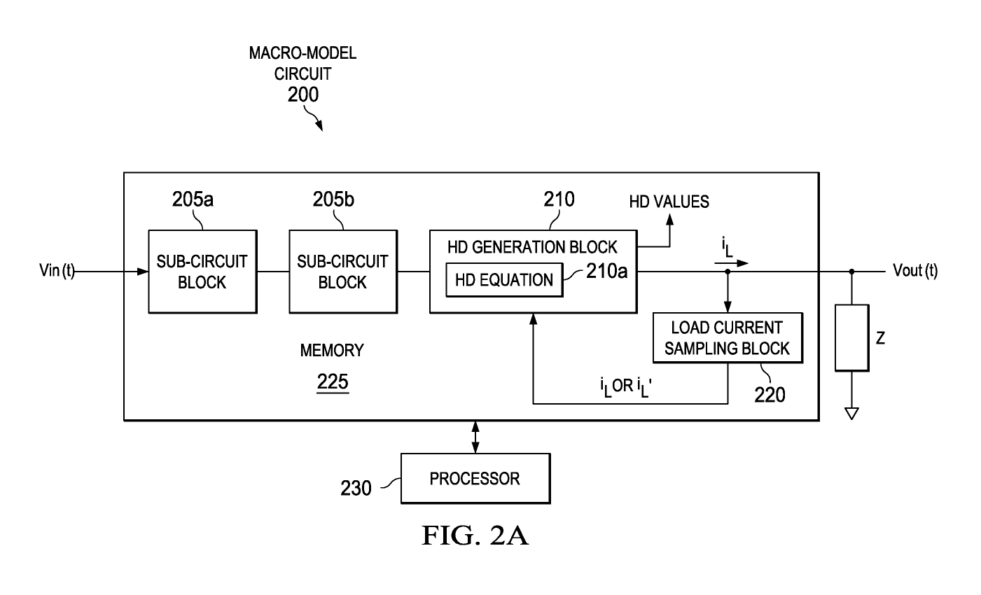

FIG. 2A is a block diagram of an example macro-model circuit 200 comprising a first sub-circuit block 205a and a second sub-circuit block 205b where the HD generation block 210 is positioned after the second sub-circuit block, shown having as iL or iL′ fed back to a HD generator block 210 by a load current sampling block 220 coupled to the Vout node, according to an example embodiment. The HD generation block 210 includes an HD equation 210a. The macro-model circuit 200 is stored in a non-transitory memory shown as 225 that is implemented by a processor 230. The memory 225 is generally a non-volatile memory.

The processor 230 can comprise a central processing unit (CPU), microcontroller unit (MCU) or digital signal processor (DSP). iL or iL′ can utilize a variety of forms and mathematical formats/equations that include iL as a main variable. Examples include, but are not limited to (where var=a variable or a constant), the following:

iL′=iL^{var} a.

iL′=iL*var b.

iL′=iL+var c.

iL′=var*iL^{var}+var d.

FIG. 2B is a block diagram of an example macro-model circuit 250 comprising a first sub-circuit block 205a and a second sub-circuit block 205b, where the HD generation block 210 is positioned between the first sub-circuit block and the second sub-circuit block, shown having iL or iL′ fed back to a HD generator block, according to an example embodiment. A significant advantage of HD generation block 210 is that it can be generally positioned anywhere in the signal path of a macro-model circuit for a wide variety of different circuits, including inserted at the front end, in the middle or otherwise between sub-circuit blocks, or at back end of the macro-model.

Regarding modelling, for non-HD macro-modeling of the electronic circuit, the HD generation block 210 can be replaced with an ideal wire (i.e., a forward gain of 1×). Upon conversion into the HD macro-model for HD modeling, this ideal wire can be replaced by the HD generation block 210 by which the HD equation is utilized (the forward gain, the coefficient a1 in a HD equation, such as Vout=a1*Vin+a2*iL²+a3*iL³, where a1 can be set to 1×, 2×, etc. . . . ).

Within the known world of “behavioral methods” for performing circuit macro-modeling for HD generation, advantages of disclosed embodiment incorporating a disclosed HD generation block having a new HD equation that incorporates the sampled load current is that the macro-modeling user will be able to simulate the impact of various output loading on HD. The denominator in the HD equation below is the impedance (Z) seen at the output node of the electronic device having a load resistor RL and feedback resistor (RFB), such as is typical for operating an operational amplifier.

IL=VOUT/(RL∥RFB), where ∥ means RL and RFB are electrically in parallel.

For instance, for an amplifier, a user using disclosed methods can simulate in these following contexts:

### a. HD vs. RL

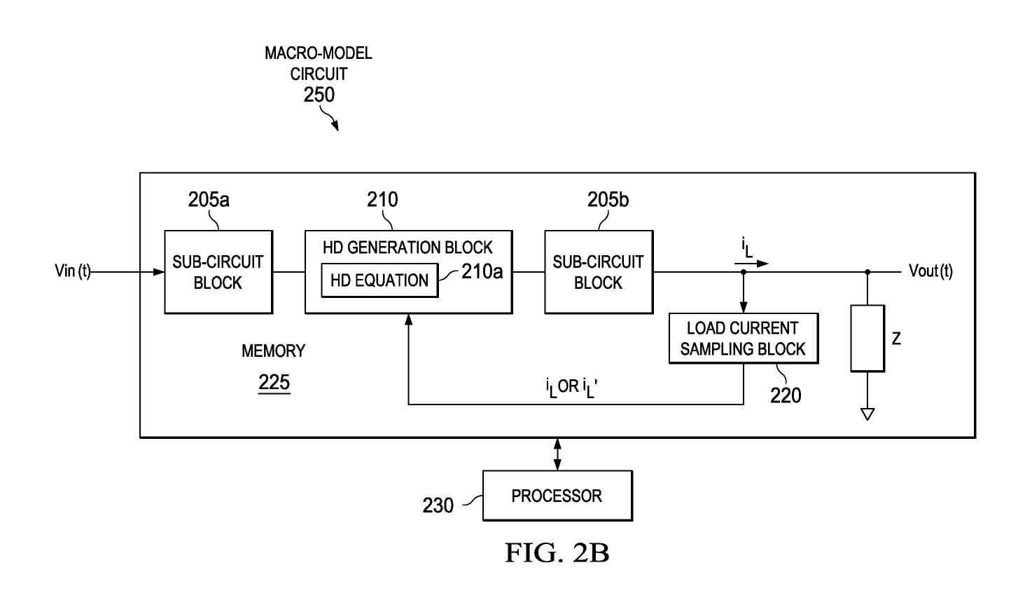

In known art of behavioral modeling, HD as a function of RL will be flat horizontal line as shown in FIG. 3A, which is highly inaccurate because in the known art there is no load current measure (therefore no RL dependency) in the HD equation. In known art Vout=a1*Vin+a2*Vin²+a3*Vin³, while for disclosed embodiments Vout has a load current measure (therefore has a RL dependency) in the HD equation, such as Vout=a1*Vin+a2*iL²+a3*iL³. For disclosed embodiments, HD as a function of RL will be provided as a decay curve as shown and thus have more accuracy. As far as the decay curve shown for disclosed embodiments it is curved because the larger the RL, the smaller the load current as a percentage of its fixed output buffer capacity which means one does not exercise the output buffer capacity too much or near its limit capacity.

### b. HD vs. RFB

In known art of behavioral modeling HD as a function of RFB will be flat horizontal line as shown in FIG. 3B because in the known art, there is no load current measure (therefore no RFB dependency) in the HD equation. In known art Vout=a1*Vin+a2*Vin²+a3*Vin³ while for disclosed embodiments in contrast for disclosed embodiments Vout has a load current measure (therefore has a RFB dependency), such as Vout=a1*Vin+a2*iL²+a3*iL³. For disclosed embodiments, HD as a function of RFB will be varying as shown. Again as with RL, because of the new added dependency of a load current measure in the HD generation circuit, an RFB dependency is created. As far as the decay curve, it is curved because the larger the RFB, the smaller the load current as a percentage of its fixed output buffer capacity which means one does not need to exercise the output buffer capacity too much or near its limit capacity.

### c. HD vs. Vout

In known art of behavioral modeling, HD as a function of Vout will have a loop steepness slope and thus be inaccurate because in the known art, there is no load current measurement in Vout=a1*Vin+a2*Vin²+a3*Vin³, so that as one increases the input amplitude (Vin) that translates into an increased output amplitude, the HD will increase as well proportional to the rate of increase or the slope of the input amplitude increase only. In contrast, for disclosed embodiments, HD as a function of output load (e.g., RL, RFB) will be varying with a significantly steeper slope tracking the behavior of the real semiconductor (e.g., silicon) chip. Again, the improved performance results because of the new dependency of load current measure in the HD generation circuit, which creates an additional dependency of output loading in addition to the voltage increase. Thus, a double impact regarding HD is provided, the first impact is the Vout increase provided by the known art, and the second impact is the newly added output load impact toward the limited fixed capacity output buffer of the electronic device. The first impact represents the numerator (“Vout”) of the load current measure (e.g., iL=Vout/(RL∥RFB)) and the second newly added impact represents the denominator such as RL∥RFB of the load current measure, such as iL=Vout/(RL∥RFB).

### EXAMPLES

Disclosed embodiments are further illustrated by the following specific Examples, which should not be construed as limiting the scope or content of this Disclosure in any way.

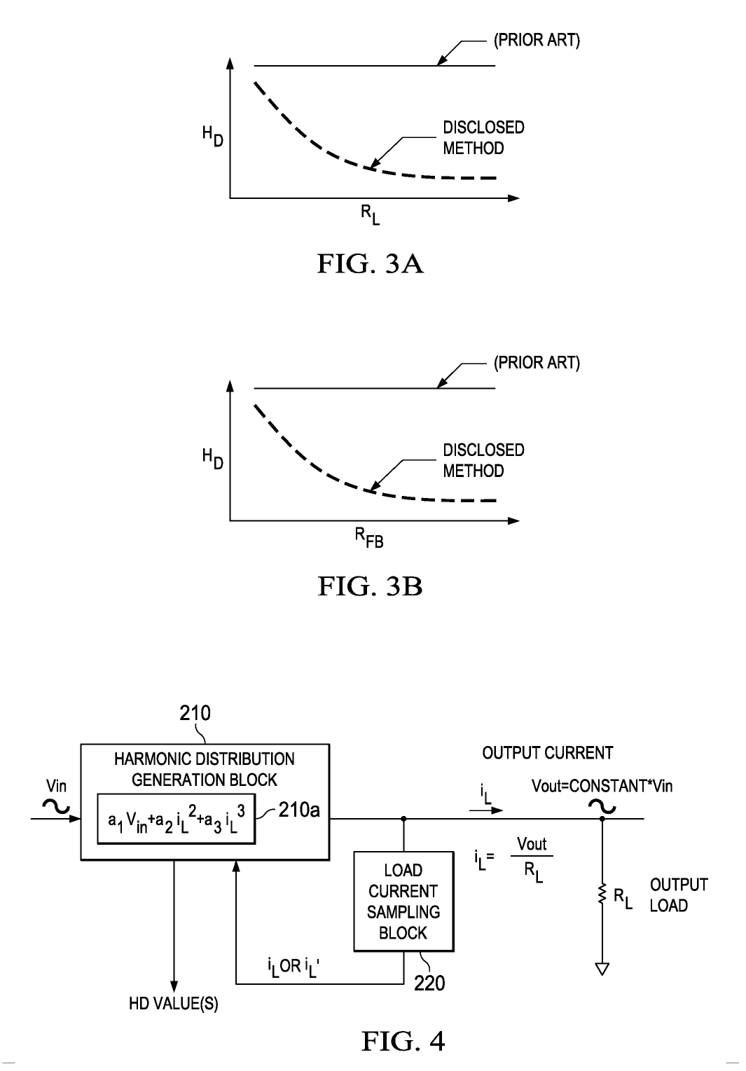

FIG. 4 shows a macro-model circuit portion that together with a mathematical manipulation described below which is used to generate HD2 and HD3 as a function of a load impedance for an electronic device.

Regarding HD2 for a Vin(t)=cos(ωt) and an Equivalent Impedance of RL:

a2*Vin²|v_{in is replaced by iL}=a2*iL²

Since Vin(t)=cos(ωt), Vout=constant×Vin (the constant is assumed to be=1 to simplify the analysis) and iL=Vout/RL, then:

$$\begin{matrix}a 2 * {iL}^{2} = a 2 * {[ cos ( ω t ) / RL ]}^{2} \\ = a 2 * {cos}^{2} ( ω t ) / {RL}^{2} \\ = a 2 / {RL}^{2} * ( 1 + cos ( 2 ω t ) ) / 2\end{matrix}$$

$$( from the half \text{-} angle formula shown above )$$

Thus, injecting iL will give rise to HD2 (i.e., 2ω) with an output load (here RL) dependency.
Regarding HD3 for a Vin(t)=cos(ωt) and an Equivalent Impedance of RL:

$$a 3 * {Vin}^{3} {\vert}_{iL -> Vin ( t )} \\ \begin{matrix}a 3 * {Vin}^{3} = a 3 * {[ cos ( ω t ) / RL ]}^{3} \\ = a 3 * {cos}^{3} ( ω t ) / {RL}^{3} \\ = a 3 / {RL}^{3} * ( cos ( 3 ω t ) + 3 cos ( ω t ) ) / 4 )\end{matrix}$$

$$( from the t riple \text{-} angle formula shown above )$$

Thus, injecting iL will give rise to HD3 (i.e., 3ω) with an output load (here RL) dependency.

Those skilled in the art to which this disclosure relates will appreciate that many other embodiments and variations of embodiments are possible within the scope of the claimed invention, and further additions, deletions, substitutions and modifications may be made to the described embodiments without departing from the scope of this disclosure.

1. A method of harmonic distortion (HD) versus output load circuit modeling, comprising:
providing a macro-model circuit including at least one sub-circuit block for modeling an electronic device and an HD generation block in a signal path of said macro-model circuit that includes an HD equation which relates a load current parameter responsive to an applied time-varying input voltage (Vin(t)), both said sub-circuit block and said HD generation block being stored in a non-transitory memory which are implemented by a processor;
responsive to receiving said Vin(t) at an input of said macro-model circuit under a set of operating conditions including an output of said macro-model circuit loaded with an equivalent output impedance (Z), generating a simulated load current (iL); feeding back said iL or another load current measure derived from said iL (iL′) to said HD generation block to provide said load current parameter for said HD generation block;
inputting said load current parameter into said HD equation so that said HD equation becomes a substituted equation, and
generating at least one simulated HD value (first HD value) under loading by said Z for said electronic device from said substituted equation.

2. The method of claim 1, wherein said HD equation is in a form comprising a1*Vin(t)+a2*iL*²+a3*iL*³, where said a1, a2 and a3 are each constants, and said iL* comprises said iL or said iL′.

3. The method of claim 1, wherein said Vin(t) is sinusoidal and at a fundamental frequency and wherein said generating comprises using a half-angle formula to generate said first HD value at two times said fundamental frequency (2^{nd} HD).

4. The method of claim 1, wherein said Vin(t) is sinusoidal and at a fundamental frequency and wherein said generating comprises using a triple-angle formula to generate said first HD value at three times said fundamental frequency (3rd HD).

5. The method of claim 1, further comprising repeating said method after changing said Z to a different Z (Z′), including:
responsive to receiving said Vin(t) at said input of said macro-model circuit under a set of operating conditions including said output of said macro-model circuit loaded with said Z′, generating a simulated load current (second iL);
feeding back said second iL or another load current measure derived from said second iL (second iL′) to said HD generation block to provide a second load current parameter for said HD generation block;
inputting said second load current parameter into said HD equation so that said HD equation becomes said substituted equation, and
generating at least one different simulated HD value (second HD value) under loading by said Z′ for said electronic device from said substituted equation.

6. The method of claim 5, further comprising generating a plot of HD versus output load using at least said first and said second HD value and said Z and said Z′.

7. The method of claim 1, further comprising implementing said method using a circuit netlist for said electronic device.

8. The method of claim 7, further comprising implementing said macro-model circuit using a circuit schematic editor or by directly typing to said circuit netlist.

9. The method of claim 1, wherein said at least one sub-circuit block for modeling said electronic device comprises a first sub-circuit block and a second sub-circuit block, and where said HD generation block is positioned between said first sub-circuit block and said second sub-circuit block.

10. A computer program product, comprising:
a non-transitory data storage medium that includes program instructions for a processor to execute a method of harmonic distortion (HD) versus output load circuit modeling, said computer program product including:
code for modeling an electronic device as macro-model circuit including at least one sub-circuit block and placing an HD generation block in a signal path of said macro-model circuit that includes an HD equation which relates a load current parameter responsive to an applied time-varying input voltage (Vin(t)), both said sub-circuit block and said HD generation block being stored in a non-transitory memory which are implemented by a processor;
code for generating a simulated load current (iL) responsive to receiving said Vin(t) at an input of said macro-model circuit under a set of operating conditions including an output of said macro-model circuit loaded with an equivalent output impedance (Z);
code for feeding back said iL or another load current measure derived from said iL (iL′) to said HD generation block to provide said load current parameter for said HD generation block;
code for inputting said load current parameter into said HD equation so that said HD equation becomes a substituted equation, and
code for generating at least one simulated HD value (first HD value) under loading by said Z for said electronic device from said substituted equation.

11. The computer program product of claim 10, wherein said HD equation is in a form comprising a1*Vin(t)+a2*iL*²+a3*iL*³, where said a1, a2 and a3 are each constants, and said iL* comprises said iL or said iL′.

12. The computer program product of claim 10, wherein said generating comprises using a half-angle formula to generate said first HD value at two times a fundamental frequency of said Vin(t) to provide a 2^{nd} HD.

13. The computer program product of claim 10, wherein said generating comprises using a triple-angle formula to generate said first HD value at three times a fundamental frequency of said Vin(t) to provide a 3^{rd} HD.

14. The computer program product of claim 10, further comprising code for repeating said method after changing said Z to a different Z (Z′) (repeating code), said repeating code including:
responsive to receiving said Vin(t) at said input of said macro-model circuit under a set of operating conditions including said output of said macro-model circuit loaded with said Z′, generating a simulated load current (second iL);
feeding back said second iL or another load current measure derived from said second iL (second iL′) to said HD generation block to provide a second load current parameter for said HD generation block;
inputting said second load current parameter into said HD equation so that said HD equation becomes said substituted equation, and
generating at least one different simulated HD value (second HD value) under loading by said Z′ for said electronic device from said substituted equation.

15. The computer program product of claim 14, further comprising code for generating a plot of HD versus output load using at least said first and said second HD value and said Z and said Z′.

16. The computer program product of claim 10, further comprising code for implementing said method using a circuit netlist for said electronic device.

17. The computer program product of claim 16, further comprising code for implementing said macro-model circuit using a circuit schematic editor or by directly typing to said circuit netlist.

18. The computer program product of claim 10, wherein said at least one sub-circuit block for modeling said electronic device comprises a first sub-circuit block and a second sub-circuit block, and where said HD generation block is positioned between said first sub-circuit block and said second sub-circuit block.
